(19) United States
(12) Patent Application Publication
(10) Pub. No.: US 2012/0256925 A1
(43) Pub. Date: Oct. 11, 2012

(54) Generation of a hierarchically-organized collection of hyperlinked graphics charts

(75) Inventors: Paul R. Stannard, Rancho Santa Fe, CA (US); Richard H. Stannard, San Diego, CA (US)

(73) Assignee: SmartDraw, LLC, San Diego, CA (US)

(21) Appl. No.: 13/066,289

(22) Filed: Apr. 11, 2011

(51) Int. Cl. G06T 11/20

(52) U.S. Cl. 345/440

(57) ABSTRACT

Documentation of processes is managed by a computer- or processor-generated collection of hierarchically-organized charts. Systematic perusal of the collection is provided by a linking mechanism operated by a computer, a processor, or a processing entity that stores, retrieves, and displays the collection. The linking mechanism enables an automatic bidirectional traversal between a step in a process illustrated in a higher-level flow diagram of the collection and a lower level flow chart illustrating the step in greater detail.

### BACKGROUND

The field includes interactive graphics programs which automatically manage the documentation of processes by a collection of hierarchically-organized hyperlinked graphics charts generated by a computer or processor.

An organization is a person or a group of persons established and structured for the purpose of achieving a goal or a set of goals. The structure of an organization includes components such as departments, divisions, teams, having responsibility for one or more processes. A process, is a sequence of interdependent and linked procedures which, at every stage, consume one or more resources to convert inputs into outputs. These outputs then serve as inputs for the next stage until a known goal or end result is reached; (Businessdictionary.com). Collectively, an organization's processes operate to achieve the goal or goals of the organization. A visual representation, that is to say, an illustration, of an organization's structure and processes is a useful tool for understanding a person's relationship to other persons in the organization and the person's role in the operations of the organization's processes. With such a representation, a person or a group of persons in the organization can communicate, plan, and act in ways that effectively advance the goals of the organization.

However, the difficulty in rendering a complete and detailed visual model scales directly, if not geometrically, with the size and complexity of an organization. As detail is added to a graphics chart modeling the relationships and roles of persons and the details of processes, the chart quickly becomes impracticably large and so detailed as to be distracting, if not incomprehensible. Parsing the single large chart into a set of separate, detailed charts risks losing the view of organizational interconnectivity that aids in an understanding of one's relationships and role in the organization.

Visual representations of various, aspects of organizational structures and processes are rendered in the form of charts. In this regard, for example, organization charts illustrate the composition of an organization and flow charts illustrate the organization's processes. A computer or a processor is programmed or constructed to execute or perform an interactive graphics application in which a computer- or processor-generated, graphics output is provided in response to commands entered by a user. The interactive graphics application may be embodied, for example, as a drawing program, as application-specific hardware, or a combination thereof. The graphics output is a visual representation of something conceived by the user. An important feature of an interactive graphics application is the capability of generating graphics charts in response to user prompts and commands.

A graphics chart is a visible diagram, map, model, or schematic composed of objects (such as lines and symbols) arranged to represent relationships among persons, units, and functions of an organization, and the arrangements, descriptions, and sequences of an organization's processes. Examples of such graphics charts include, without limitation, organization charts and flow charts.

A graphics chart has a format, that is to say, a defined set of rules about the structure of the diagram, map, model, or schematic being generated. For example, a flow chart is constituted of symbols representing steps of a process and lines which connect the symbols to show sequences in which the steps occur.

As a flow chart illustrating a moderately complex process is composed by a drawing program, it can begin to sprawl over a page in an increasingly complex layout that becomes ever more difficult to manage and to comprehend. If the flow chart has varying amounts of detail, its parts may be classified into levels that are illustrated in separate charts presented on separate pages. Typically, a user follows verbal and/or symbolic prompts on toolbars and/or menus to manually page through, identify, and retrieve interrelated charts by menu-driven input actions. The result is a collection of flow charts that is not easily traversed without many user actions. Often the user actions follow illogical paths that are difficult to retrace to a starting point.

Accordingly, it is desirable to be able to construct a hierarchically-structured collection of interrelated flow charts constituting an ordered, multilevel illustration of processes and sub-processes that is easily, quickly, and logically traversed in forward and return directions with minimal user action.

Usability, and thus value, of a hierarchically-structured collection of interrelated flow charts would be enhanced by provision of an automatic, computer-executed means of traversing the levels of the collection along paths that connect summarizing processes with more detailed summarized sub-processes.

The invention provides a solution to the problem of obtaining a tractable visualization of an organization's processes by enabling the creation of a collection of hierarchically-organized charts generated by a computer or processor. Any process step represented in a flow chart contained in the collection can be automatically linked to another flow chart in the collection with a more detailed illustration of the process step. The link is automatically traversed and is bidirectional. Automatic traversal occurs in response to a command input; bi-directionality enables multi-directional trans-level movement through the hierarchical organization.

In this regard, an organization's processes are classified into a hierarchy of increasing detail from any higher level to a next-lower level in which each level of detail is illustrated by a flow chart representing steps of the process. As a result of classification, a process step in any level can summarize a more detailed, multi-step sub-process in a lower level of greater detail. Such a step is a summarizing step. A chart visually representing the summarized process' in a greater degree of detail is obtained in an orderly way by provision of a hyperlink from a chart shape visually representing the summarizing step to a chart in a lower level containing the greater degree of detail.

### SUMMARY

Easy, fast, and logical traversal in forward and return directions through hierarchically-ordered, computer- or processor-generated collection of graphics charts is provided by a linking mechanism that is generated and operated by a computer, a processor, or a graphics processing entity that stores, retrieves, and displays the collection. The linking mechanism enables automatic, bidirectional traversal of a hierarchically-structured collection of interrelated flow charts constituting an ordered, multilevel illustration of processes and sub-processes.

### BRIEF DESCRIPTION OF THE DRAWINGS

FIG. 1 is a block diagram of a computer or processor system for generating, storing, retrieving, and displaying graphics charts.

FIG. 2 is a pictorial representation of a graphics chart output by a computer or processor system, which illustrates a process of an organization.

FIG. 3 is a flow chart illustrating a graphics application process according to which a computer or processor automatically generates and hyperlinks hierarchically-related charts.

FIG. 4 is a pictorial representation of a high level chart output by a computer or processor system, which is generated from the graphics chart of FIG. 2.

FIG. 5 is a pictorial representation of a low level chart output by a computer or processor system, which is generated from the graphics chart of FIG. 2.

FIG. 6 is a pictorial representation of a high level process flow chart output by a computer or processor system, which is a member of a collection of hierarchically-organized hyperlinked graphics charts.

FIG. 7 is a pictorial representation of an intermediate-level process flow chart output by a computer or processor system, which is hyperlinked to the high level flow chart of FIG. 6.

FIG. 8 is a pictorial representation of a low level process flow chart output by a computer or processor system, which is hyperlinked to the intermediate level flow chart of FIG. 7.

FIG. 9 is a pictorial representation of a shape in the intermediate level flow chart of FIG. 7 showing a symbol or icon representing a hyperlink.

FIG. 10 is a pictorial representation of a job map chart output by a computer or processor system, which is a member of the collection of hierarchically-organized hyperlinked graphics charts.

FIG. 11 is a pictorial representation of an organization chart output by a computer or processor system, which is a member of the collection of hierarchically-organized hyperlinked graphics charts.

### SPECIFICATION

A “graphics application” refers to a graphics program, process, method, or equivalent. A “graphics processor” refers to a programmed computer, special purpose processor, networked process, or equivalent. Use of the term “graphics application” alone to explain an example, an illustration, an embodiment, or a mode of use should be understood to also explain the example, illustration, embodiment, or mode of use with respect to a “graphics processor”, absent some indication to the contrary. The principles to be presented in this specification are applicable to computer- and/or processor-generated graphics charts.

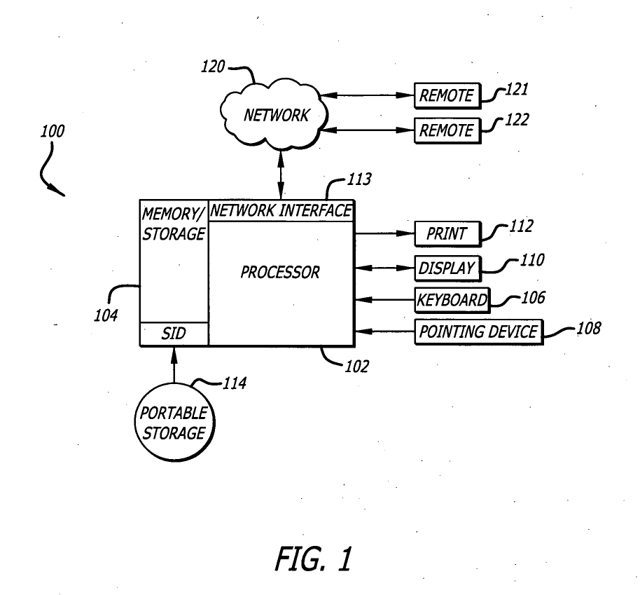

FIG. 1 illustrates an operational environment, and a computer system in which a graphics application automatically generates and hyperlinks graphics charts according to the principles explained below. The computer system 100 includes a programmed general or special purpose computer or processor 102 having memory and storage 104. The memory comprises, for example, RAM. The computer or processor 102 receives keystroke inputs from a keyboard or equivalent device 106 and receives other inputs from a manually-operated pointing device 108, such as a mouse. A display 110 provides a visual graphical user interface, which can also provide data and command inputs by touch screen operations. The display 110 and a printer 112 generate respective outputs. A network interface 113 enables the computer system 100 to operate via a network 120, which may be local or global, with one or more remote entities 121, 122. The remote entities may be any one or more of other computers or processors, servers, websites, network nodes, and other equivalents. Graphics application programming may be stored, accessed, and executed solely at the computer system, or by way of a network to which the computer system 100 is connected. The computer or processor 102 may receive commands, including commands for generating and hyperlinking graphics charts, generated by any one or more of keystrokes on the keyboard 106, drag-and-drop actions involving the pointing device 108 and the display 110, point-and-click actions involving the pointing device 108 and the display 110, and touch-screen actions involving the display 110. The computer or processor 102 generates visual output, including graphics charts, by display via the display 110 and/or the printer 112.

In FIG. 1, the computer or processor 112 is enabled to execute a graphics application by programming received from a computer-readable storage medium which may be constituted of a portable storage device 114 such as a CD, DVD, memory stick, or other equivalent device, or by programming downloaded via network interface 113. One example of such an application is the SmartDraw® Business Graphics software. So programmed, the computer or processor 102 constitutes a graphics processor and is enabled to execute a graphics application that automatically generates and hyperlinks graphics charts in collections of hierarchically-organized hyperlinked charts generated by a computer or processor.

Preferably, a graphics chart generated by a graphics processor is manipulated and stored in the form of a file. The contents of the graphics chart are organized as a set of records in the file, each containing the data necessary to enable the storage, retrieval, editing, and display of an object such as a line or a shape in the graphics chart. The graphics processor uses a file handling capability that enables it to systematically store and retrieve a graphics chart file by means of an access path unique to the file.

Generation of hierarchically-linked graphics charts produced by a computer or processor involves selecting, deleting, and/or moving objects and generating hyperlinks between graphics chart files in response to user-entered commands. We have found that it is beneficial to automatically generate graphics charts and couple them with hyperlinks in conjunction with the execution of those commands in order to enable the creation and systematic perusal of collections of hierarchically-related graphics charts with minimal user actions. In this regard, the generation of detailed low-level graphics charts hyperlinked with higher-level graphics charts includes self-initiated actions of a graphics process and/or a graphics processor that are not themselves literally required by user actions or user commands. In this sense, these actions are automatic.

According to this specification, starting with a high level graphics chart in a collection of hierarchically-organized graphics charts, a graphics process generates a lower level graphics chart from content of the high level graphics chart and links the lower level graphics chart with a shape in the high level graphics chart. When generating and linking the lower level graphics chart, the graphics process performs automatic acts, that is to say, it executes self-initiated actions that are not literally required by a user action.

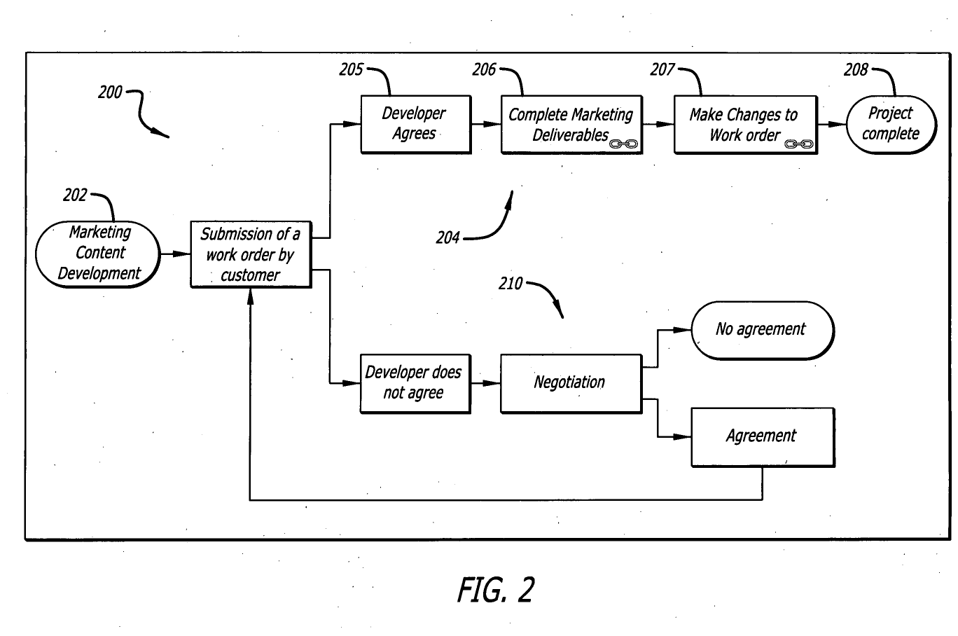

With reference to FIG. 2, consider a flow chart 200 generated by a graphics processor according to FIG. 1. The flow chart 200 illustrates a marketing content process of an organization. As much of the marketing content process as is illustrated includes ten shapes connected by lines so as to be organized into a process flow that proceeds from left to right. The process has a root 202 and two branches 204 and 210. Following the root 202, each shape in the flow chart represents a step in the marketing content process. Manifestly, addition of more steps to the process, and/or illustration of steps presently included in the process in greater detail would increase the layout complexity of the chart and the density of information contained in the flow chart. Given that illustration of the marketing content process by means of the flow chart is useful to an organization, it is desirable to present a high level version of the chart with a minimum number of steps having highly summarized descriptions, while providing access to one or more lower level illustrations of summarized process steps. Preferably the lower level illustrations are themselves constituted of flow charts showing sub-processes summarized at the higher level. A collection of flow charts would contain “parent” processes at a high level and “child” sub-processes at one or more lower levels.

For example, in the flow chart of FIG. 2, the sequence of four connected shapes 205-208 in the branch 204 illustrate in detail a developer agreement sub-process of the marketing content development process. Furthermore, the sub-process is summarized in the shape 205. It is desirable to remove the greater detail of the sub-process 205-208 from the flow chart 200, without removing the detail of the subprocess altogether from a graphic representation of the marketing content development process. A solution to the problem of simplifying the marketing content development process is presented by removal of the developer agreement sub-process 205-208 to a lower level flow chart that is linked to the high level flow chart at a point where a summary of the sub-process is visible. In the example of FIG. 2, the summary is contained in the shape 205 in the first flow chart 200, and the solution is to generate from the first flow chart 200 a second flow chart constituted of the sequence of connected shapes 205-208, and to link the second flow chart to the summary shape 205 in the first flow chart 200. As a result, the relationship between the first and second flow charts would be hierarchical, with the first chart being the high level element and the second chart being the low level element.

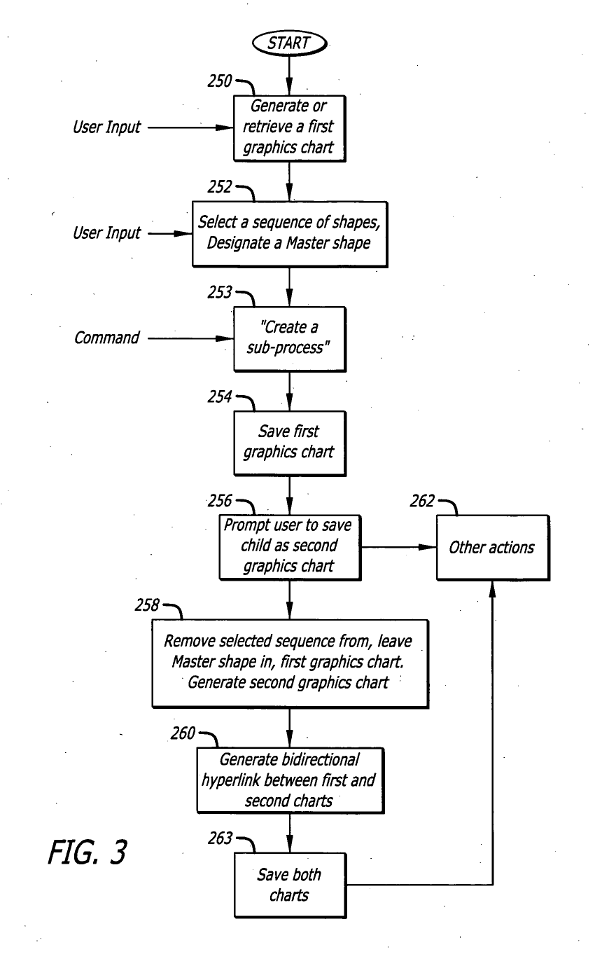

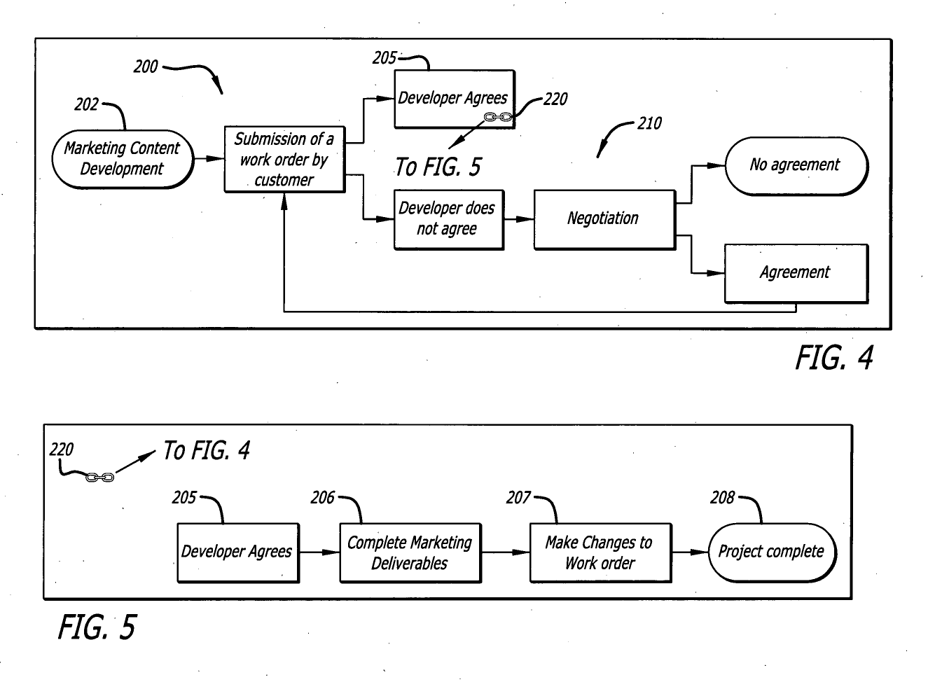

A method executable by the graphics processor 100 for automatically generating and hyperlinking graphics charts is illustrated by the flow chart of FIG. 3. For illustration, but without limitation, the method is explained with reference to the process flow chart of FIG. 2. In FIG. 3, the graphics chart 200 is retrieved or generated by a graphics processor at 250 in response to user commands. At 252 a user selects the sequence of connected shapes in the branch 204 of the flow chart 200. The shapes are selected in the order 208, 207, 206, 205. The last-selected shape 205 is displayed with solid selection indicators (the eight small dark squares distributed along the periphery of the shape 205) so as to indicate a first shape, denoted here as the “master” shape, which will serve as the anchor of a hyperlink to a graphics chart. The user then enters a command “Create sub-process” at 253. In response to This command, the graphics processor saves the graphics chart 200 to disc at 254 and generates a prompt at 256 asking the user to save the child process 205, 206, 207, 208 as a separate, lower-level graphics chart. If the user declines, the method exits to other actions at 262. When the user accepts the prompt, the method begins a response to the “Create sub-process” command at 258. With reference to FIGS. 4 and 5, beginning at 258 the graphics processor automatically:

removes all of the selected sequence of shapes from the first graphics chart 200, except the master shape 205, and generates a second or lower level graphics chart 270 with the selected sequence of shapes (258 of FIG. 3);

generates a bidirectional hyperlink (indicated by the link icon 220) between the master shape 205 in the high level graphics chart 200 that summarizes the removed sequence and the lower level graphics chart 270 (260 of FIG. 3); and,

saves the files containing the first and second graphics charts in a collection of related, hierarchically-organized hyperlinked graphics charts generated according to the method of FIG. 3.

With further reference to FIGS. 2, 4, and 5, the method is set forth in greater detail, for a file system embodiment, as follows. The “Create sub process” command is described and illustrated by the following pseudo-code illustration of graphics application programming:

1. The graphics chart 200 is saved to disk 114, but remains open in the graphics application;

2. The text “Developer agrees” is read from the master shape 205;

3. The user is prompted to save the child process 205, 206, 207, 208 to the same file access path as the parent process 200, with the text “Developer agrees” from the master shape 205 as the proposed file name;

4. If the user chooses not to save the file, the command is cancelled, otherwise processing in response to the “Create sub process” command proceeds by automatic execution of the following steps:

5. A duplicate copy of the disk file containing the graphics chart 200 is made and saved to the disk;

6. A hyperlink to the access path of the duplicate copy of the disk file is added to the master shape 205 in the graphics chart 200;

7. The master shape 205 in the graphics chart 200 is deselected;

8. The shapes 206, 207, 208 that remain selected in the graphics chart 200 are deleted and the graphics processor 100 automatically reformats the remaining shapes of the graphics chart 200 to the form illustrated in FIG. 4. The access path to the now-modified graphics chart 200 does not change;

9. The original instance of the graphics application calls a second instance of the graphics application to open the duplicate file;

10. The original instance of the graphics application saves its file to disk and remains open;

11. The duplicate copy of the graphics chart 200 as seen in FIG. 3 opens in the second instance of the graphics application;

12. A hyperlink to the access path of the graphics chart 200 seen, in FIG. 4 is added to the master shape 205 in the duplicate copy of the graphics chart 200;

13. All shapes that are selected in the duplicate copy of the graphics chart 200 are deselected;

14. All shapes in the duplicate copy that represent steps not selected in the original copy of the graphics chart 200 are selected in the duplicate copy;

15. All other shapes and lines (such as a title block and connecting lines) in the duplicate copy are selected in the duplicate copy;

16. All selected shapes in the duplicate copy are deleted and the duplicate copy is automatically reformatted to the form illustrated in FIG. 5; and,

17. The duplicate copy is saved to disk but remains open in the second instance of the graphics application.

There are now two instances of the graphics application running: one with the parent process open and one with the child process open and each is linked to the other. The method can be repeated for as many processes and sub-processes as may be useful.

With further reference to FIGS. 4 and 5 and to the preceding pseudo-code illustration of programming for the “Create sub process” command, the method automatically executes programming for addition of a hyperlink from an open file to an external file. For example, but without limitation, the following routine can be employed by the “Create sub process” command to create a hyperlink from a shape in one graphics chart to another graphics chart. A bi-directional hyperlink is generated by executing the routine once to link a first graphics chart to a second chart and once again to link the second graphics chart to the first:

1. The access path to the external file (parent or child process) is stored in memory (RAM, for example) as a string;

2. The access path to the document that contains the shape (child or parent process) is stored in memory as a string;

3. The two strings are compared;

4. The backslash {“\”} in the path of the external file that precedes the file directory that is the first to not match the original file is replaced with a unique delimiter such as two forward slash characters {“//”}; the characters that follow the delimiter constitute a relative path to the external file;

5. The path to the external file is stored with the shape both in memory and in the disk file when the file is saved; and,

6. When the user executes a command to link to the external file from a shape (by clicking on the special hyperlink symbol 220 for example), the relative path is first used to locate the file within the same directory as the file containing the shape (including sub directories), and open it; otherwise,

7. If no such file is found, a copy of the path to the external file is made in memory. Then the relative path marker {“//”} is replaced with a normal path delimiter {“\”} and the full path is used to locate the external file and open it.

For example, For example, presume the file access path for the file containing the first graphics chart 200, illustrated in FIG. 4, is:

C:\Directorl\subdirectory\collectionsubdirectory1\marketingcontentdevelopment.xxx;

and, the file access path for the file containing the second graphics chart 270, illustrated in FIG. 5, is:

C:\Directorl\subdirectory\collectionsubdirectory2\Developer agrees.xxx;

then, the hyperlink stored with the master shape 205 in the file containing the first graphics chart 200 is:

C:\Directory\subdirectory//collectionsubdirectory2\Developer agrees.xxx.

Printing Company Example:

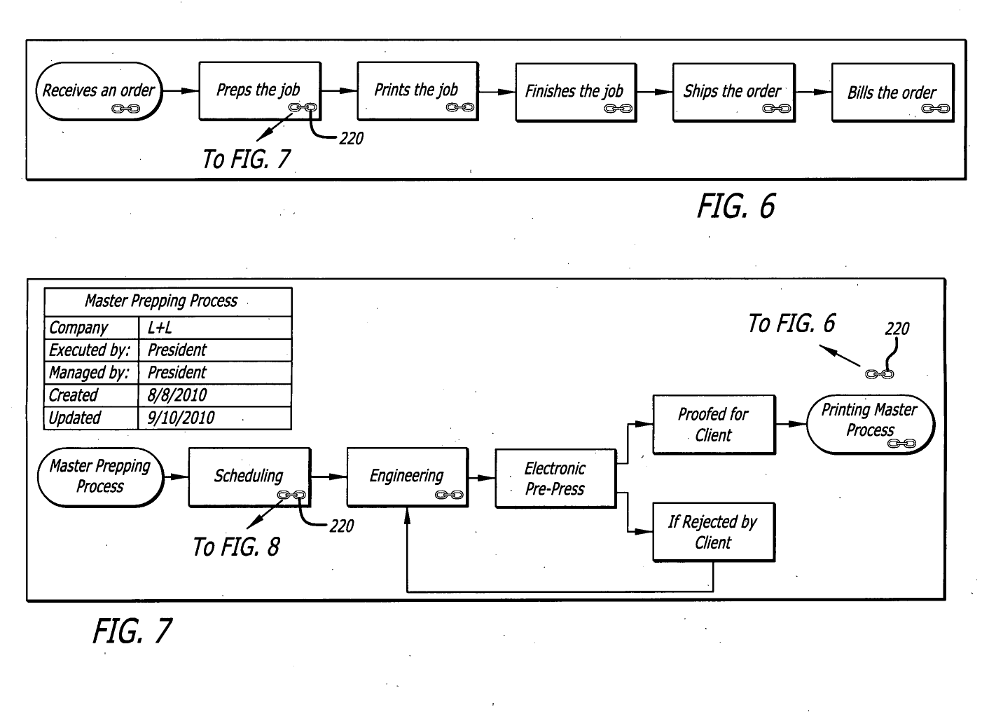

The system and method described above and illustrated in FIGS. 1-5 are useful for generating and managing process flow visuals (charts and diagrams) which, in turn, support the discovery, documentation, and management of an organization's processes using a collection of hyperlinked visuals. In this regard, instead of attempting to document a complex process with a single flow chart, a user can break the process into a hierarchy of processes and sub-process that are hyperlinked together. Any major activity within an organization can be summarized as a process with small number of steps, and a collection of hierarchically-ordered graphics charts can be built upon this insight. This is shown in FIGS. 6-11, using the example of a printing company having an organization and a number of processes.

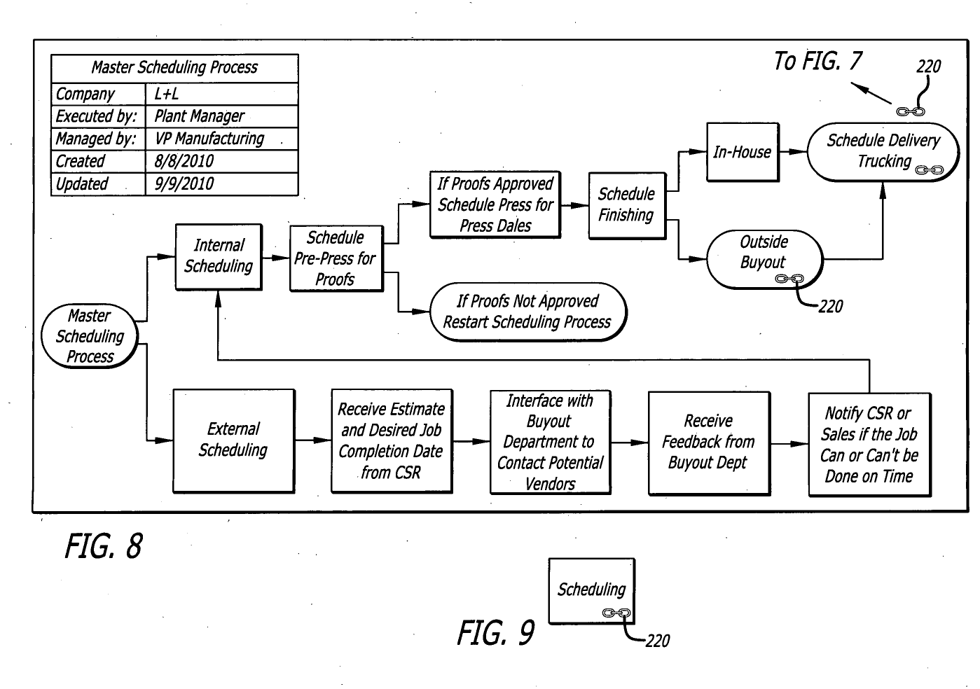

For example, in FIG. 6, the printing company's production process is summarized into six steps. Each of these six steps is a summary of a more detailed sub-process. For example, “Preps the job” in FIG. 6 summarizes a more detailed sub-process as per FIG. 7. In the same way, some of the steps in the sub-process of FIG. 7 summarize other more detailed sub-processes. For example “Scheduling” in FIG. 7 summarizes the more detailed sub-process illustrated in FIG. 8. Even the sub-process of FIG. 8 includes the steps “Outside Buyout” and “Schedule Delivery” that summarize other sub-processes. In other words, FIGS. 6-8 represent the company's processes as a hierarchy of parent and child processes, where each child process represents an increasing level of detail.

Preferably, but not necessarily, a hierarchically-organized collection of hyperlinked process illustrations generated for the printing company uses the well-established custom of representing a process visually as a flowchart. Preferably, but not necessarily, this customary usage can be extended by imposing a “one page rule” to the effect that any flowchart that represents a process or a sub-process should fit on a single page (or screen) at such a scale that the text on the chart is readable. Use of the one page rule imposes a standard for the degree of detail possible in any chart. It compels a complex process to be divided into hierarchy of simpler processes with no more than, say, 10 or so steps, rather than as a single flat process that would be represented as a very large flowchart with hundreds of steps.

The use of flow charts to visually represent a process is very easily and effectively adapted for a hierarchical collection by hyperlinking the steps in a process illustrated by a high level flow chart that are summaries of more detailed sub-processes to the flowcharts for those detailed processes. The hierarchy is modeled by a collection of flowcharts that are hyper linked together in the same way as the hierarchy. In the printing company example of FIGS. 6-8, the “preps the job” shape is hyperlinked to the visual below it that represents the “preps the job” process. Likewise the “Scheduling” shape in the “preps the job” flowchart is hyperlinked to the “master scheduling process” flowchart. In FIGS. 6-8, each shape that is hyperlinked to a sub-process includes a special area of the marked with a hyperlink symbol 220 that is easily understood. A user accesses the detailed sub-process associated with a shape that summarizes it by clicking on the area of the shape marked with the hyperlink symbol 220. Similarly, a user returns from those flow charts illustrating sub-processes that are summarized at a higher level by clicking on the hyperlink symbol 220 that is positioned in the upper right quadrant of those flow charts.

When a collection is built, the underlying hierarchical model of processes results in a systematic discovery of all of the processes in the printing company being modeled. In this regard, as information is gathered, the first task is to identify a top-level process that is not part of any other process and describe it as small number of steps. Presuming that the maximum number of steps is contained by the “one page rule”, each step in this process is usually a summary of a more detailed process. The next task is to document the child processes that each of the steps in the top-level process summarizes. Again presuming use of the “one page rule”, this often leads to steps in the child processes that are themselves summaries of more detailed processes. These “grandchild” processes are then documented and so on, in a recursive process until the desired level of detail is achieved. By employing this recursive method of identifying and documenting processes, it is possible to systematically discover and identify all of the processes involved in executing a top-level process. In contrast, traditional methods identify processes in a sequential haphazard fashion by interviewing employees rather than by the systematic recursive and complete mode that is required to posses the information from which a hierarchical collection is generated.

The hierarchical model can be used to assign accountability to each process by breaking a complex processes with a large number of steps into a hierarchy of simpler processes with a small number of steps. This division is not arbitrary if the rule is that all of the steps in a root level process with no summary steps are executed by a single position within the printing company, or by an individual that belongs to a class of positions. (For example—all executives, all customer service position . . . ). If a process involves two different positions for some of its steps, then it is divided into two different processes: one for each position. It is desirable to use this rule by assigning a single position as being “accountable” for executing each process. It also desirable to assign a position as being accountable for designing the process. In this regard, changes to the process and to the documentation can only be made by the position that is accountable for its design.

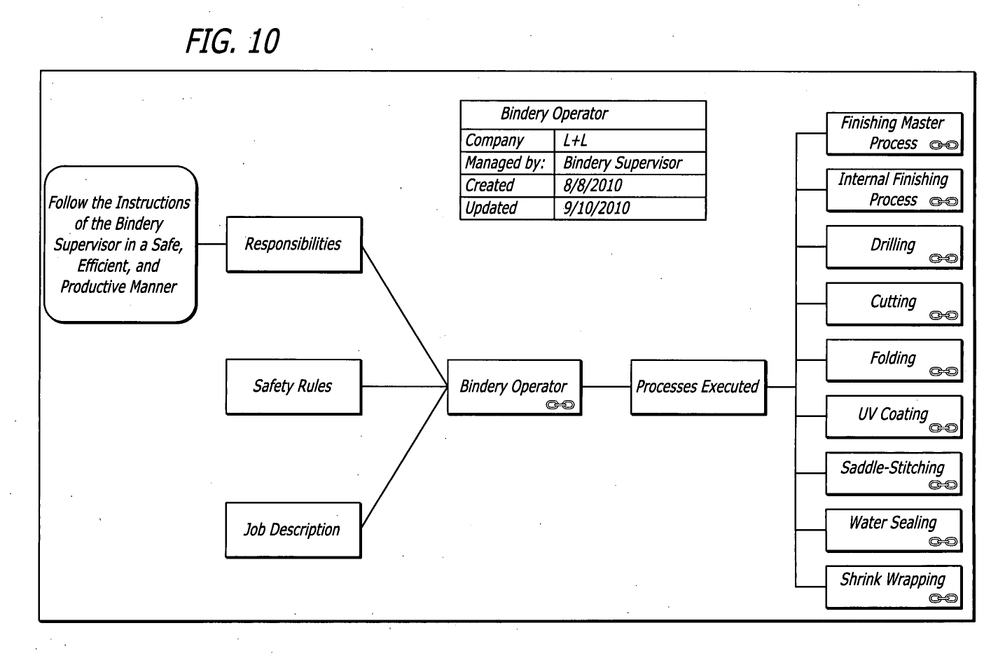

It is also desirable to generate a “job map” visual to represent the processes that each position in the printing company is accountable for, and other attributes of that position such as job description and safety rules. For example, a job map of the processes that a Bindery Operator position is responsible for is illustrated in FIG. 10. As shown, the job map has a radial format. The position title is in the center with shapes attached radially for the processes that this position executes, and other attributes of the position such as job description. The shapes for other attributes may be hyperlinked to other visuals that show greater detail. The “Processes Executed” shape is the head of a tree with a child shape for each process that the position executes. It should be evident that a job map can be created for each position in the organization.

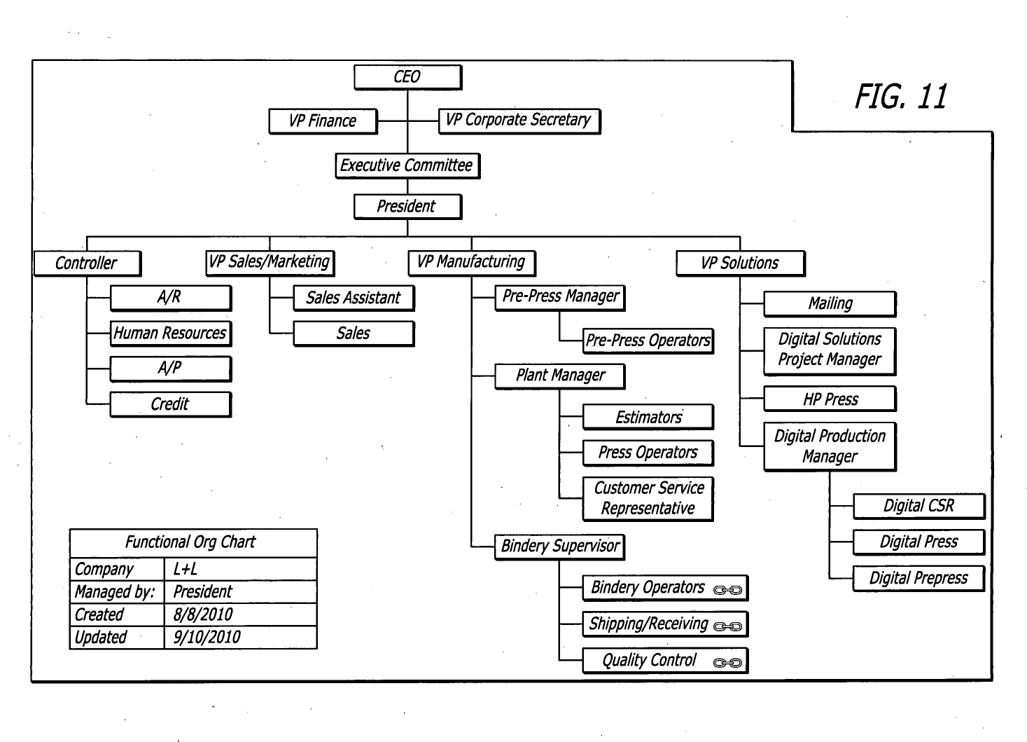

It is also desirable to model accountability in the printing company by providing a hyperlink from the flowchart of each process to the job map visual for the position that is accountable for executing it and to the job map visual of the position that is accountable for designing it. Consider, for example, the hierarchy of positions within the printing company as represented by the organizational chart of FIG. 11. Each shape in this chart represents a position, and is hyperlinked to its job map visual. Each job map visual is hyperlinked via the central shape (the “Bindery operator” shape in FIG. 10, for example) back to the organizational chart; each process shape in the job map for a position is hyper linked to the flowchart for that process (see FIG. 10 in this regard). Hence a user may view the organization chart and then click on a link in a position shape to view the job map for that position. The user may then click on the hyperlink in a process shape in the job map to view the flowchart for that position. Further, a user may view the documentation for all of the processes that a particular position is accountable for.

Thus, using the teachings of this specification, it is possible to create a collection of hyperlinked visual representations of all of the processes in an organization, the positions within an organization, and the job maps for each position, to create a browsable electronic representation of the operations of an organization. The collection of visuals for all of the processes, the organization chart, and the job maps hyperlinked in the manner described create an electronic model of the operations of the company. A user is thereby enabled to browse from the uppermost level of a complex process to systematically observe increasing detail of each step using hyperlinked flowcharts. For any process the user is enabled to use a hyperlink to view a job map and place in the organization of the position accountable for executing and designing the process. In a similar way, a user may examine the list of processes that a position is accountable for by clicking on the hyper link in its shape in the organization chart and viewing the job map. Finally, a user is able to examine the list of processes that a position is accountable for by clicking on a hyperlink in its shape in the organization chart and viewing the job map. The user is able to see the details of the steps of the processes that this position is accountable both for executing and defining by clicking on the hyperlinks in the shapes for these processes in the job map.

The scope of patent protection afforded the novel graphics process and graphics processor described and illustrated herein may suitably comprise, consist of, or consist essentially of the elements described. Further, the novel graphics process and graphics processor disclosed and illustrated herein may suitably be practiced in the absence of any element or step which is not specifically disclosed in the specification, illustrated in the drawings, and/or exemplified in the embodiments of this application.

Moreover, although an invention has been described with reference to particular embodiments, it should be understood that various modifications can be made without departing from the spirit of the invention. Accordingly, the invention is limited only by the following claims.

1. A method executed by a computer system operative to generate, store, and display a collection of graphics charts, comprising the computer-executed steps of:
displaying a first graphics chart containing a plurality of connected objects;
receiving a selection command indicating a sequence of connected objects in the plurality of connected objects; and then, in response to the received selection command:
automatically creating a second graphics chart containing the indicated sequence of connected objects;
automatically removing at least a portion of the sequence of connected objects from the first graphics chart; and,
automatically adding a hyperlink between the first and second graphics charts.

2. The method of claim 1, in which the computer-executed step of automatically removing at least a portion of the sequence of connected objects from the first graphics chart includes-retaining a master object of the sequence of connected objects in the first graphics chart.

3. The method of claim 2, in which the predetermined objects include the master object in the first graphics chart and a copy of the master object in the second graphics chart, and the computer-executed step of automatically creating a hyperlink between predetermined objects in the first and second graphics charts includes automatically creating a hyperlink anchored in the master object and terminated in the copy of the master object.

4. The method of claim 3, in which the hyperlink is bidirectional.

5. The method of claim 3, in which the hyperlink includes a first link portion directed from the first to the second graphics chart and a second link portion directed from the second graphics chart to the first graphics chart.

6. The method of claim 3 in which the first and second graphics charts are flow charts, the master object contains a process step summary, and the sequence of connected objects contains a plurality of steps summarized by the process step summary.

7. The method of claim 3 in which the first and second flow charts are contained in respective files and the hyperlink in the master object to the second process flow chart comprises a file access path to the file containing the second flow chart, in which the file access path includes a first portion that matches the corresponding first portion of a file access path to the file containing the first flow chart, followed by a relative access path portion to the file containing the second flow chart, and a delimiter between the first and second portions.

8. A computer-executed method for generating hierarchically-related process flow charts, comprising:
receiving a selection command indicating a sequence of connected shapes in a first process flow chart;
the selection command indicating a master shape in the sequence; and then, in response to the selection command:
automatically creating a second process flow chart containing the indicated sequence of connected shapes;
automatically removing all of the sequence of connected shapes except the master shape from the first process flow chart; and,
automatically adding a hyperlink in the master shape to the second process flow chart.

9. The method of claim 8 further including the computer-executed step of automatically adding a hyperlink from the second to the first process flow chart.

10. The method of claim 8 in which the first and second flow charts are contained in respective files and the hyperlink in the master shape to the second process flow chart comprises a file access path to the file containing the second flow chart, in which the file access path includes a first portion that matches the corresponding first portion of a file access path to the file containing the first flow chart, followed by a relative access path portion to the file containing the second flow chart, and a delimiter between the first and second portions.

11. The method of claim 10 in which the hyperlink is stored with the master shape in the file containing the first flow chart.

12. A graphics-processor-executed method for hierarchically relating a first process flow chart containing a shape summarizing a process contained in a second process flow chart by the graphics-processor-executed step of automatically adding a first hyperlink from the shape to the second process flow chart.

13. The graphics-processor-executed method of claim 12 in which the first and second flow charts are contained respective files and the first hyperlink comprises a file access path to the file containing the second flow chart, in which the file access path includes a first portion that matches the corresponding first portion of a file access path to the file containing the first flow chart, followed by a relative access path portion to the file containing the second flow chart, and a delimiter between the first and second portions.

14. The method of claim 13 in which the hyperlink is stored with the shape in the file containing the first flow chart.

15. The graphics-processor-executed method of claim 12, further including the graphics-processor-executed step of automatically adding a second hyperlink from the second to the first process flow chart.

16. The graphics-processor-executed method of claim 15, further including the graphics-processor-executed step of automatically adding a third hyperlink from an organization chart to the first process flow chart.

17. The graphics-processor-executed method of claim 16, further including the graphics-processor-executed step of automatically adding a fourth hyperlink from a position in the organization chart to a job map chart.
